(19) United States
(12) Patent Application Publication
(10) Pub. No.: US 2008/0186498 A1
(43) Pub. Date: Aug. 7, 2008

(54) Reflector having a trapezoid reflection and method for precision photo-scanning for recognition of an object

(75) Inventor: Hans-Erich Gubela, Sasbachwalden (DE)

Correspondence Address: COLLARD & ROE, P.C., 1077 NORTHERN BOULEVARD, ROSLYN, NY, 11576, US

(73) Assignee: IMOS GUBELA GmbH

(21) Appl. No.: 12/012,533

(22) Filed: Feb. 4, 2008

(30) Foreign Application Priority Data
Feb. 5, 2007 (DE) 10 2007 006 405.7

(51) Int. Cl. G01N 21/55; G02B 27/10

(52) U.S. Cl. 356/445; 359/619

(57) ABSTRACT

A reflector having a lenticular light entry surface produces a reflective signal in the shape of a trapezoid. It thereby allows a method for precision scanning of objects, particles, or gases, having a particularly slight diameter of the transmitter beam and a changeable distance of up to close to 0 mm between the reflector and the transmitter/receiver.

### CROSS REFERENCE TO RELATED APPLICATIONS

Applicant claims priority under 35 U.S.C. §119 of German Application No. 10 2007 006 405.7 filed Feb. 5, 2007.

### BACKGROUND OF THE INVENTION

1. Field of the Invention

The present invention relates to a reflector, a light barrier having a reflector, and a method for the detection of objects in a light barrier.

2. The Prior Art

Reflective light barriers, in which the transmitter and receiver stand opposite a reflector, are used in light sensor systems. These reflectors consist, in most cases, of a plurality of reflective elements in the form of triples or reflective spheres. The size and configuration of the reflective elements determine the shape of the beams and the offset of the beams that the reflected light undergoes. If the light barrier is intended to measure the passage of a very small part, for example a thread, the light beam of the light barrier must also be very small in diameter. In this way, a significant part of the light beam is interrupted when the thread crosses the beam path. This requirement arises because the light barrier requires a clear difference in signal between an undisturbed light beam progression and a light beam progression that is disturbed by an object to be observed.

DE 197 27 527 to GUBELA points out the problems of beam offset with regard to the size of the reflective elements, for the use of a fine light beam of the reflected light barrier, and teaches a ratio to be observed between the ray contour and the triple size. This teaching shows that the size of the reflective elements must clearly be smaller than the beam diameter of the transmission beam of the light barrier. A great problem results from this requirement for precision scanning with light barriers, if the light barrier intends to use a particularly small diameter of the light beam for precision scanning. This problem arises because micronizing reflective elements accordingly involves great technical effort. Furthermore, the undesirable refraction effects increase accordingly, with the reduction in size of the reflective elements, depending on the wavelength of the light.

### SUMMARY OF THE INVENTION

The present invention now takes a completely different path towards a sensor system method that solves the problems described in surprisingly simple manner. Furthermore, two new types of reflectors are shown, which are particularly suitable for the method.

The idea according to the invention is to differentiate between the beam shape of the light beam that is emitted, the transmitter beam, and the light beam that is reflected by the reflector, and to configure the transmitter beam with great precision, as desired, in terms of its diameter. In accordance with the invention, the reflected beam is also deformed into a light field in the shape of a trapezoid, in which the receiver is disposed.

For the precision scanning, it is sufficient that only one of the two beams is clearly disturbed or interrupted by the object to be observed or the gas to be observed. For this purpose, transmitter and receiver are positioned, with regard to the reflector so that the transmitter beam and the reflected beam do not possess any common path in space. The transmission beam can be as small as desired in terms of its diameter and its contour. The reflected beam is clearly changed, in terms of its contour, by the reflector, into a line composed of many points, so that only a part of the reflected beam hits the receiver. For this purpose, transmitter and receiver must stand in a line relative to one another that corresponds to the position of the line produced by the reflector crosswise to its surface.

If the transmission beam is disturbed by 70%, for example, the output of the line-like reflected beam is also reduced accordingly. With this situation, the receiver also receives a signal reduced by 70% as compared with the undisturbed signal. The clear change in value of the received signal, as a percentage, is sufficient for the receiver to perform signal interpretation.

Now one could ask why the reflected beam is formed into a line and not uniformly scattered in all directions. Scattering in all directions would mean scattering the energy in untargeted manner; however, it is important that the receiver retains as much energy as possible, in order to be able to clearly differentiate level variations of the energy flow. To bring about a great retention of energy, the light must be distributed as little as possible. In other words, the reflected light must be directed at a point or a few points in order to retain the energy. The method according to the invention chooses a plurality of points that form a line. The line could also be deformed, for example into the shape of an arc.

The greatest energy retention is achieved by means of a point-shaped light deflection, such as described, for example, in DE 101 19 671 A1, to Gubela senior, in which a deflection triple reflector deflects the incident light. Likewise, the use of a triple structure that emits only two light beams would be possible, as shown in WO2006/136381 A2 to Gubela et al., FIG. 3. These reflector systems have the disadvantage that the receiver must be disposed at a corresponding angle to the reflector, in order to be able to receive the transmission beam. If a change in the distance of the receiver from the reflector occurs, the distance between the transmitter and the receiver must also be changed. This requirement arises because in the case of point-shaped reflection, transmitter, receiver, and reflector always form a triangle. The position of transmitter and receiver relative to one another is determined by the angle between the transmission beam that impacts the reflector and the reflected reflection beam.

Now the next problem of precision scanning becomes clear. The distance of the receiver is supposed to be changeable, without having to change the distance between transmitter and receiver.

The distance between reflector and receiver is supposed to be changeable as a function of the object to be observed. In the final analysis, the receiver is supposed to be able to almost set down onto the reflector, or to move away from the reflector. Because the reflector responds to the transmitter beam with a line parallel to the reflector surface as a reflected beam, it produces an approximately two-dimensional light field. If transmitter and receiver are disposed so that they move towards the reflector or away from it on the plane of this light field, then transmitter and receiver can always correspond with one another by way of this light field.

The light field produced by the new type of reflector according to the invention, described in greater detail below, corresponds to an imaginary trapezoid. The smallest side of the trapezoid is formed from the plurality of points formed into a line on the reflector surface, which the reflector according to the invention emits as a reflected beam. The trapezoid widens with an increasing distance from the reflector. As long as transmitter and receiver move in the plane of the trapezoid, the function of the light barrier is assured.

Because the reflector responds with a trapezoid, the structure of its reflective elements in terms of shape and size is unimportant. They can be triples having a size of 6 mm, which bring about a beam offset of up to 6 mm, or micro-triples having a width of 170 micrometers, which bring about a beam offset that is just as small. The triple shape, in terms of its configuration, is also unimportant. They can be pyramidal triples whose individual mirrors are triangles, they can also be cubical triples whose individual mirrors are squares, or triples having any other special shape, as they are shown in DE 102 28 013 B4, Gubela senior, FIG. 4 to FIG. 15. The reflective elements of the reflector can also be reflective spheres.

The present invention frees the developer from the need to build reflective elements having an ever smaller structure, in order to allow scanning with a high-precision light beam. This freedom arises because the invention does not require the micronized reflective elements for precision scanning. The invention solves the problem of the size and the shape of the reflected element and the problem of the beam offset brought about by the reflective element.

### BRIEF DESCRIPTION OF THE DRAWINGS

Other objects and features of the present invention will become apparent from the following detailed description considered in connection with the accompanying drawings. It should be understood, however, that the drawings are designed for the purpose of illustration only and not as a definition of the limits of the invention.

In the drawings, wherein similar reference characters denote similar elements throughout the several views:

FIG. 1 shows a pyramidal triple having mirror surfaces and a triple center;

FIG. 2 shows a reflector array of pyramidal triples of FIG. 1 viewed in a perpendicular direction;

FIG. 3 shows a reflector in section wherein the back of the reflector is formed from pyramidal triples as shown in FIG. 2;

FIG. 4 shows a cubical triple or so-called full cube made up of mirror surfaces and a triple center;

FIG. 5 shows a reflector array of cubical triples of FIG. 4 viewed in a perpendicular direction;

FIG. 6 shows a reflector in section wherein the back of the reflector is formed from cubical triples and the light entry side is covered with convex lenticulars;

FIG. 7 shows a reflective sphere of transparent material;

FIG. 8 shows an array of reflective spheres;

FIG. 9 shows a reflector formed from a reflective array as in FIG. 8 and having lenticulars disposed above the light entry surface;

FIG. 10 shows the reflector of FIG. 3 wherein the back of the reflector, which is made up of pyramidal triples, was covered with a metallic protective layer;

FIG. 11 shows an embodiment of a reflector having cubical triples with a metallization on the backs of the triples, an adhesive layer, a delay film, and another adhesive layer on which a lenticular film having lenticulars forms the light entry surface;

FIG. 12 shows an embodiment of a reflector having reflective spheres;

FIG. 13 shows an embodiment of a reflector as in FIG. 12 where the lenticulars are concave rather than convex;

FIG. 14 shows the reflector of FIG. 3 with a transmitter of a light barrier standing closely opposite the reflector;

FIG. 15 shows the line progression of the lenticulars of a reflector according to an embodiment of the invention;

FIG. 16 shows the narrowest side of the light trapezoid produced by the lenticulars; and

FIG. 17 shows a reflector according to an embodiment of the invention having a lenticular surface structure, a transmitter, and a transmitter beam reflected as a reflected beam in the shape of a trapezoid and received by a receiver positioned in the plane of the light trapezoid.

### DETAILED DESCRIPTION OF PREFERRED EMBODIMENTS

Now that the method according to the invention for the use of a reflection field in the shape of a trapezoid has been described, a new type of reflector will now be presented, which is able to produce such a reflection field in the shape of a trapezoid as a reflected beam.

### Production of the Reflector

A conventional reflector, as an injection-molded part or a reflective foil, which is made up of a plurality of reflective elements, in the form of triples or reflective spheres of any desired size, is selected for producing the reflector according to the invention. A lenticular structure that consists of convex or concave lenses is laid over the light entry surface of the reflector. Convex lenticular films, as they are used for so-called blurred images in printing technology, for allowing spatial image representations, have proven themselves to be most effective.

The number of lenticulars per square inch, which is important in the case of image representations, is not decisive for the effect here. However, it is advantageous, in order to retain the data that might be additionally set onto the transmission beam, to select the width of the lenticular lens to be greater than the width of the individual reflection elements of the reflector array.

The transmitter light of the light barrier hits the lenticular lenses and is guided into the reflector, reflected there by the reflection elements, for example a triple or sphere, and now formed into a line at the exit from the lenticular surface of the reflector, which exits offset by 90° from the running direction of the lenticular lenses, and produces a light field in the shape of a trapezoid as a reflected beam. If the receiver is situated anywhere in the light field in the shape of a trapezoid, it can evaluate the signal.

The effect of this combination of reflection and lenticulars is so surprising that it is possible to work with the smallest transmitter beam. If transmitter and receiver are accommodated in a common housing, the light barrier head, as is usual in the case of most reflected light barriers, it is possible to move as close as desired to the new type of reflector with the light barrier head.

The range of such a reflector, with reference to a reflected light barrier, is dependent on the energy distribution, in other words on the format of the emitted trapezoid. The energy distribution can be influenced by the shaping of the lenticular lens, and can be calculated by means of the simulation technology for lens design that is currently available.

Turning now in detail to the drawings,

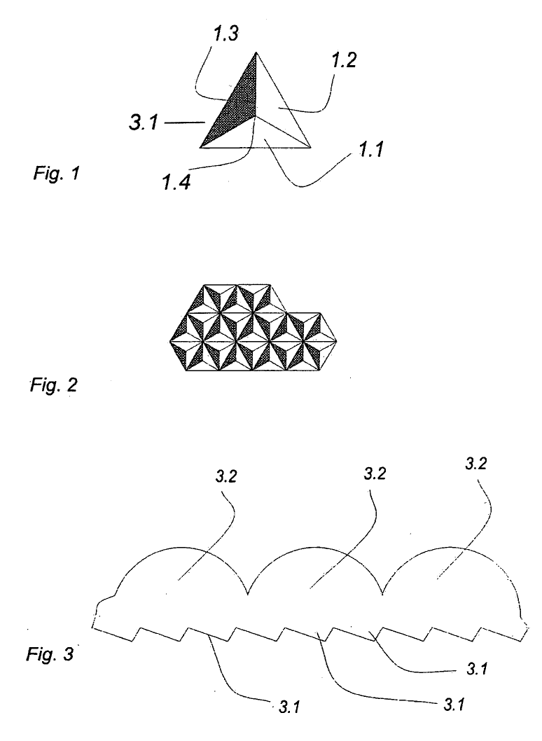

FIG. 1 shows a pyramidal triple 3.1 having the mirror surfaces 1.1, 1.2, and 1.3, and the triple center 1.4. FIG. 2 shows a reflector array of pyramidal triples of FIG. 1, viewed in a perpendicular direction. The triples are joined together, as reflection elements, to form a reflector body.

FIG. 3 illustrates the principle of the reflector according to the invention for generating a light trapezoid as a reflected beam. The reflector is shown in section. The back of the reflector is formed from pyramidal triples 3.1, as shown in FIG. 2. Convex lenticulars 3.2 are disposed above the light entry side. The lenticulars 3.2 are shown to be clearly wider than the triples 3.1, in this example.

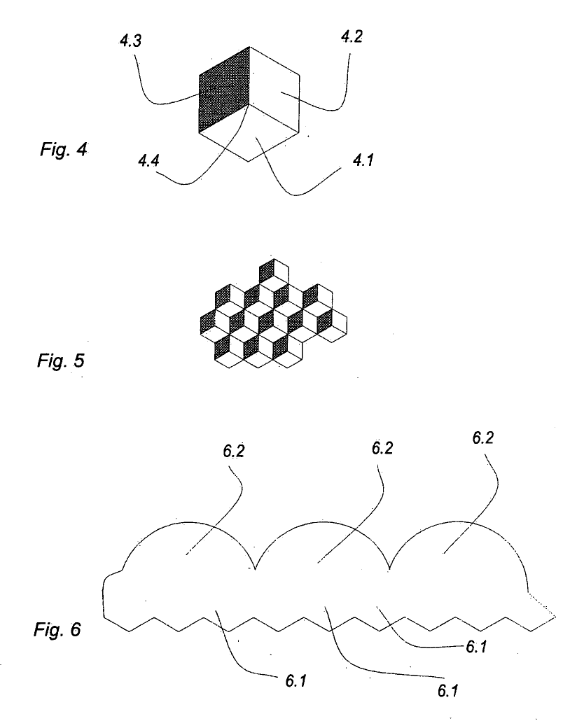

FIG. 4 shows a cubical triple, a so-called full cube, consisting of the mirror surfaces 4.1, 4.2, 4.3, and the triple center 4.4. FIG. 5 shows a reflector array of cubical triples of FIG. 4, viewed in a perpendicular direction.

FIG. 6 illustrates the principle of the reflector according to the invention, shown in section. The back of the reflector is formed from cubical triples 6.1. The light entry side of the reflector is covered with convex lenticulars 6.2.

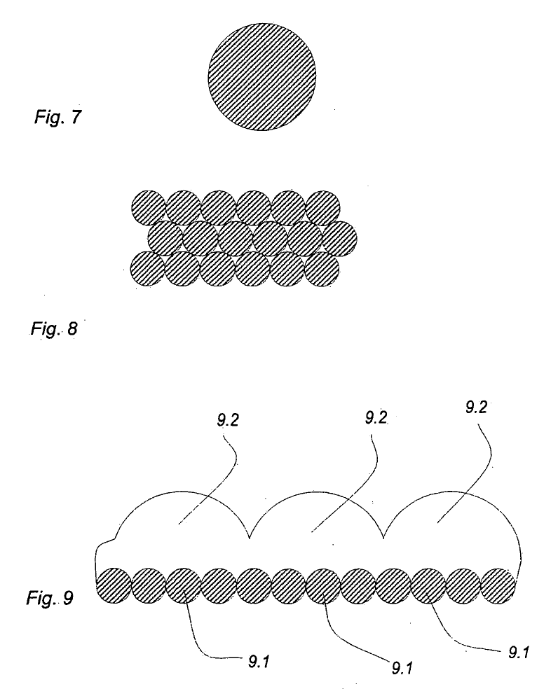

FIG. 7 shows a reflective sphere of transparent material, for example glass or plastic. FIG. 8 shows an array of reflective spheres. Such reflective spheres can be selected to be particularly small, so that the point density of the array is increased.

FIG. 9 illustrates the principle of the reflector according to the invention, whereby this time, the reflector is formed from a reflective sphere array 9.1 as in FIG. 8, and lenticulars 9.2 are disposed above the light entry surface.

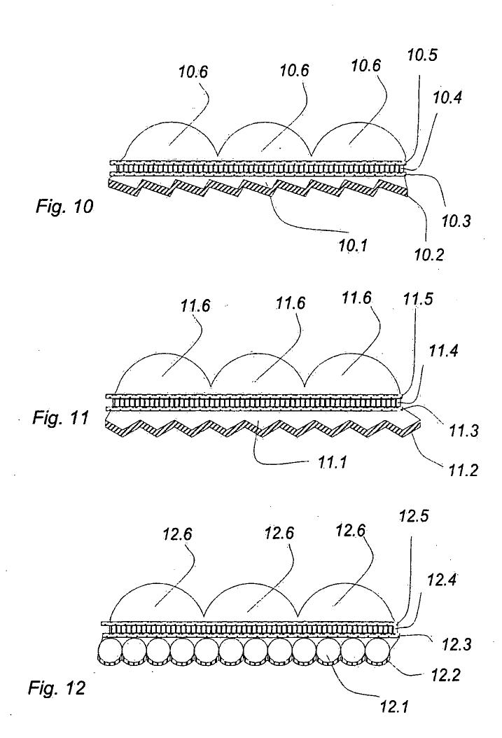

FIG. 10 shows the structure of an exemplary reflector as in FIG. 3. In addition, the back of the reflector, which is made up of pyramidal triples 10.1, was covered with a metallic protective layer 10.2 of aluminum, copper, silver, or gold. An adhesive layer 10.3 is applied to the light entry side of the triple array, and a delay film 10.4 on top of that layer. Above delay film 10.4, a lenticular film having the lenticulars 10.6 is laminated on with another adhesive layer 10.5. The delay film is shown only as an example. It is also possible to do without the delay film, which also holds true for the following examples. Likewise, it is possible to do without the metallization of the back of the triple array, and instead, a box can be applied to the back in order to protect the triples from dust and water. That also holds true for the other examples.

FIG. 11 shows the structure of an exemplary reflector having cubical triples 11.1, with a metallization 11.2 of the backs of the triples, an adhesive layer 11.3, a delay film 11.4, and another adhesive layer 11.5, on which a lenticular film having the lenticulars 11.6 forms the light entry surface.

FIG. 12 shows the structure of an exemplary reflector having reflective spheres 12.1. The reflective spheres possess a metallization 12.2 on the side facing away from the light entry side. There is an adhesive layer 12.3 on the reflective spheres, onto which a delay film 12.4 is laminated. Above delay film 12.4, there is another adhesive layer 12.5, which fixes a lenticular film having lenticulars 12.6 in place.

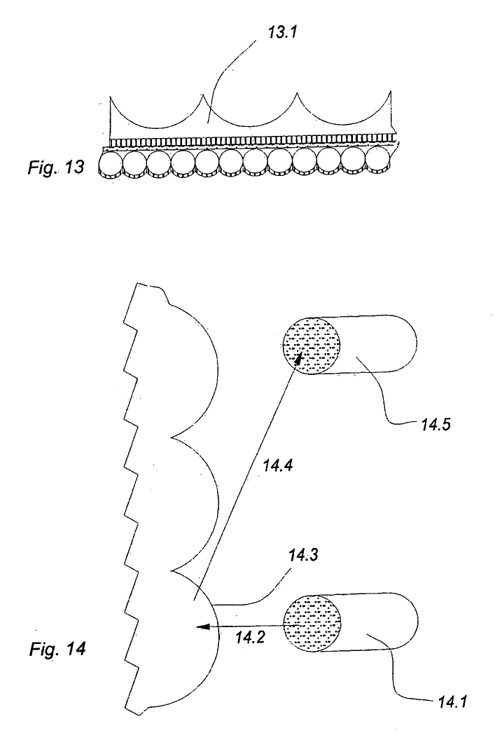

FIG. 13 shows the structure of an exemplary reflector as in FIG. 12, but here the lenticulars 13.1 are configured to be not convex, but rather concave.

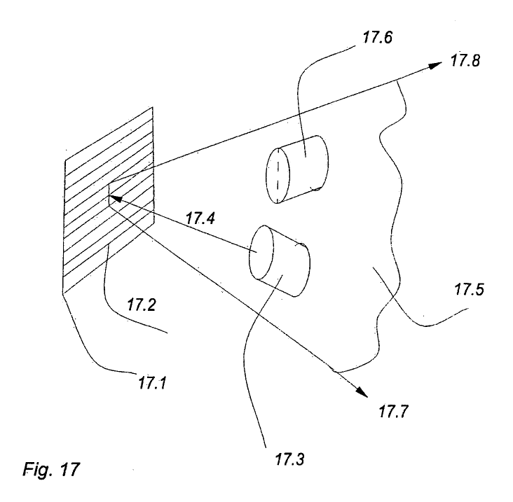

FIG. 14 shows a reflector as shown in FIG. 3, with a transmitter 14.1 of the light barrier standing closely opposite it. The transmitter beam 14.2 hits a lenticular of the reflector, is reflected within the reflector, and leaves the reflector as a reflected beam 14.4, and reaches the receiver 14.5 of the light barrier. This result occurs because the receiver stands on an imaginary line with the transmitter, whereby this imaginary line runs rotated by 90° crosswise to the line progression of the lenticulars 14.3. Thus, the receiver can receive the light trapezoid produced by the reflector. In other words, the beam path of the light transmitted by the transmitter 14.1 and received by the receiver 14.5 forms a plane that runs perpendicular to the line progression of the lenticulars 14.3. As in the case of the exemplary embodiment according to FIG. 17, as well, an evaluation unit, not shown, connected with the receiver 14.5, serves for the evaluation of the light signals.

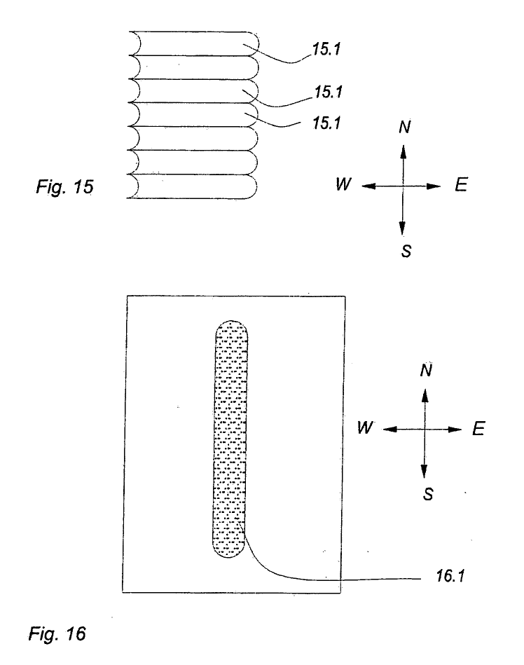

FIG. 15 shows the line progression of the lenticulars 15.1 of the reflector according to the invention. In this example, the lenticulars run in a preferred direction from west to east.

FIG. 16 shows the narrowest side 16.1 of the light trapezoid produced by the lenticulars. The orientation of the trapezoid takes place crosswise to the progression of the lenticulars in FIG. 15. Because the lenticulars run from west to east in this example, the narrowest side of the trapezoid produced by the reflected beam runs from north to south.

FIG. 17 shows the reflector 17.1 according to the invention, having the lenticular surface structure 17.2, the transmitter 17.3, the transmitter beam 17.4, which is reflected as a reflected beam 17.5 in the shape of a trapezoid, and received by the receiver 17.6, which is positioned in the plane of the light trapezoid 17.5. The trapezoid of the reflected beam spreads out in the directions 17.7 and 17.8.

The present invention opens up new possibilities for light sensor systems for precision scanning of small objects or gases, even at very short distances from the reflector. No triple array micronized in complicated manner is necessary; the scanning beam, as the transmission beam, can be as small in diameter as desired. In order to produce a small light beam, a perforated mask disposed in front of the transmitter is sufficient. Any reflective reflector is sufficient to produce a reflector according to the invention, for example a reflective foil onto the light entry surface of which a lenticular film is laid. The invention shows a surprisingly simple solution for a sensor system problem that has been the subject of complicated designs for decades.

Using this invention, it is possible to build sensor systems, particularly small, micronized sensor systems, for the detection of thin threads, small particles, gases, or smoke. With this, micronized smoke alarms or particle counters according to the reflected light barrier principle are also possible.

In summary, the following should be stated:

A reflector having a lenticular light entry surface produces a reflected signal in the shape of a trapezoid. It thereby allows a method for precision scanning of objects, particles, or gases, having a particularly slight diameter of the transmission beam and a changeable distance of up to close to 0 mm between the reflector and the transmitter/receiver.

Accordingly, although several embodiments of the present invention have been shown and described, it is to be understood that many changes and modifications may be made thereunto without departing from the spirit and scope of the invention as defined in the appended claims.

What is being claimed is:

1. A reflector comprising
(a) a reflector body having a light entry side and a back side facing away from said light entry side, said back side having a reflective structure; and
(b) a lenticular structure disposed on the reflector body and covering the light entry side, said lenticular structure having a plurality of lenses that extend in a preferential direction.

2. The reflector according to claim 1, wherein the reflective structure has a plurality of reflection elements that are joined together, and wherein each lens has a width measured crosswise to the preferential direction greater than a width of each reflection element.

3. The reflector according to claim 2, wherein the reflection elements are identical.

4. The reflector according to claim 1, further comprising a delay layer disposed between the reflector body and the lenticular structure.

5. The reflector according to claim 4, wherein the delay layer comprises a λ/4 delay layer.

6. The reflector according to claim 4, wherein the lenticular structure is a film that has said plurality of lenses.

7. The reflector according to claim 6, wherein the film is glued onto the reflector body or onto the delay layer.

8. The reflector according to claim 1, wherein at least part of the lenses are convex.

9. The reflector according to claim 1, wherein at least part of the lenses are concave.

10. A light barrier comprising:
(a) a reflector comprising a reflector body having a light entry side and a back side facing away from said light entry side, said back side having a reflective structure, and a lenticular structure disposed on the reflector body and covering the light entry side, said lenticular structure having a plurality of lenses that extend in a preferential direction;
(b) a light transmitter for transmitting light in a light transmission direction onto the reflector;
(c) a light receiver directed at the reflector in a light reception direction; and
(d) an evaluation unit for evaluating light signals received by the light receiver;
wherein a plane that extends through the light transmitter and the light receiver stands perpendicular to the preferential direction.

11. A method for detecting objects in a light barrier, comprising the steps of:
(a) transmitting a light beam onto a reflector via a light transmitter;
(b) reflecting the light beam in the reflector and widening the light beam into a light field having a trapezoid shape;
(c) receiving the light beam reflected in the reflector by a light receiver disposed in the light field; and
(d) evaluating the light beam received by the light receiver via an evaluation unit.
